(19) United States
(12) Patent Application Publication
(10) Pub. No.: US 2007/0004841 A1
(43) Pub. Date: Jan. 4, 2007

(54) Thickening agent for cured in place pipe resin

(76) Inventor: Michel Gosselin, Clinton, CT (US)

Correspondence Address: Royal W. Craig;Ober, Kaler, Grimes & Shriver, Attorneys at Law, 120 East Baltimore Street, Baltimore, MD, 21202-1643, US

(21) Appl. No.: 11/478,372

(22) Filed: Jun. 29, 2006

Related U.S. Application Data
(60) Provisional application No. 60/694,957, filed on Jun. 29, 2005.

(51) Int. Cl. C08K 3/22

(52) U.S. Cl. 524/433; 524/436

(57) ABSTRACT

A thickening agent for thickening polyester resin used in Cured-In-Place-Pipe open-molding processes. The thickening generally comprises a calibrated mixture of neutral polyester resin carrier with an active agent comprising approximately 98.5% Magnesium Oxide (MgO) paste and 1.5% anhydrous Calcium Chloride. The Calcium Chloride is powdered and combined in powder form with the MgO paste and binder for addition to the polyester resin prior to curing for the Cured-In-Place process.

### CROSS-REFERENCE TO RELATED APPLICATION(S)

The present application derives priority from U.S. Provisional Application No. 60/694,957 filed Jun. 29, 2005.

### BACKGROUND OF THE INVENTION

1. Field of the Invention

The present invention relates to the thermoset resins used in Cured-In-Place Pipe applications and, more particularly, to a thickening agent for use in the Cured-In-Place-Pipe curing process.

2. Description of the Background

The fiber reinforced plastics (FRP) industry today is experiencing significant growth as more applications are being found for reinforced plastic. This is largely owing to its durability, strength, and expected lifetime.

One application in particular is the Cured In Place Pipe (CIPP) industry, in which piping systems are repaired through the application of resin compounds to damaged pipe surfaces while the pipes remain buried underground. The steps of the CIPP process are generally as follows:

Step 1: a fiber matrix liner, (woven/non-woven, needled felt/glass) is saturated in resin. There are a variety of commercial resins all of which are thermosetting polyester composites with reinforcing fibers or fibers that act as a carrier for the resinous material. The unsaturated polyester resins are made from a reaction of one or more glycols with an unsaturated dicarboxylic acid or its anhydride, or with a mixture of the unsaturated acid or its anhydride with a saturated dicarboxylic acid or its anhydride.

Step 2: A resin saturated liner is installed in an existing pipe through a manhole or the like. The resin-saturated tube is then inverted in the pipe or pulled into place. A variety of resins may be used to repair pipes during the above-described CIPP process, and typical CIPP applications will use either PU, PE and some PVC coating to encapsulate the resin and liner.

Step 3: Water/air is used to fill and invert the liner within the pipe and is continually added to maintain a constant pressure. The water pressure keeps the liner pressed tightly against the walls of the pipe. The liner may be pulled into place and inflated with air/water. Also the liner may be pulled into place and a calibration hose is inverted into the liner, inflating it against the host pipe.

Step 4: The water in the pipe is circulated through a heat exchanger where it is heated and returned to the pipe. The hot water cures the thermosetting resin, causing it to harden into a structurally sound, jointless pipe-within-a-pipe. Saturated hot air (steam) can be heated and injected into the pressurized liner to cure the resin system.

Step 5: Water pressure/air is released and the liner is trimmed and cut with a remote control cutting device or man-entry techniques. The lined pipe is ready for immediate use with no excavation whatsoever.

In the formation of the matrix in Step 1, the resin typically comprises an unsaturated polyester resin blended with (1) one or more monomers capable of crosslinking with the vinyl groups in the polyester, (2) one or more polymerization initiators (catalysts), (3) promoters for use in combination with the initiator, and (4) various other additives which impart desired characteristics to the matrix upon cure or which will improve the processing and/or curing properties of resin.

Typically, in addition to the foregoing a thickening agent is added to give the polyester resin-based molding compositions an improved maturation profile. The thickening agent is usually added after the catalyst has been added and mixed, and is added into the same vessel or mixing tank for about 5 to about 10 minutes. Any means of compounding the thickening agent into a resin system is applicable, i.e., inline mixing or batch mixing. The reactive mixture of resin, catalyst and thickening agent is applied to a fabric/liner to be installed to a surface of a pipe, structure or surface and the resin and the thickening agent become chemically bound. Conventional thickening agents include alkaline materials such as magnesium oxide (MgO), hydroxide, calcium oxide, zinc oxide, barium oxide, magnesium hydroxide, and calcium hydroxide, and mixtures thereof. Magnesium oxide and hydroxide, for example, are available from various commercial sources, such as Barcroft Company.

The alkaline material interacts with residual acidity in the polyester resin component to build viscosity, which makes the resin impregnated liner easier to apply to the pipe.

Unfortunately, the conventional thickening process or “maturation” can be rather slow, requiring several days to achieve a viscosity appropriate for sheet molding. Moreover, with conventional thickening agents such as magnesium oxide or hydroxide they require an engineer to calculate proportions and monitor thickening rates per batch. Calculations are batch dependent and extremely sensitive to the tenth and even hundredth of a pound. Thickening may require 35-42 pounds of thickening agent per drum of resin, yet the drums of resin come filled to the brim, with no room for addition of additives. For example, U.S. Pat. No. 6,692,802 to Nava issued Feb. 17, 2004 shows a polycarbodiimide thickener. Unfortunately, batch to batch inconsistencies are common resulting in failures due to drain-down. The cost to manufacture is very expensive, and the fabricator has to mix 5-10% by weight into the resin and must add sufficient catalyst to cure the “chemical thickener” as well. If the polycarbodiimide system thickens too rapidly before wet-out is complete, the remaining material will be disposed and possible failure of the carrier fabric.

It would be greatly advantageous to provide a thickening agent that yields a reduced thickening time for workability (3-4 hours adjustable to 6-10 hours, if desired, depending on the resin and conditions), and with improved thickening results relative to the prior art compositions.

### SUMMARY OF THE INVENTION

It is, therefore, the primary object of the present invention to provide a thickening agent for universal use with most any unsaturated polyester resins used in the Cured-In-Place-Pipe open-molding processes that is inexpensive, easier to use, shortens maturation, and reaches a higher level of effectiveness than prior art thickening agents.

It is another object to provide a thickening agent that increases viscosity to effectively apply shear/pressure forces to the material without drain-down or migration from the surface to be coated.

It is another objective to provide a thickening agent that increases in viscosity and can be reduced in viscosity to prolong wetting, working time and assure workability.

These and other objects are accomplished with a new and improved thickening agent for thickening polyester resin used in Cured-In-Place-Pipe open-molding/closed molding processes. The thickening agent generally comprises a calibrated mixture of neutral polyester resin carrier with an active agent comprising approximately 98.5% Magnesium Oxide (MgO) paste and 1.5% anhydrous Calcium Chloride. The Calcium Chloride is powdered and combined in powder form with the MgO paste and binder for addition to the polyester resin prior to curing for the Cured-In-Place process.

### DETAILED DESCRIPTION OF THE PREFERRED EMBODIMENT

The present invention is a thickening agent that effectively and economically thickens most any unsaturated polyester resins for Cured-In-Place-Pipe open-molding/closed molding that reaches a higher level of effectiveness than prior art thickening agents. The present thickening agent is provided in concentrated form so that only small amounts need to be added per drum/inline (static) mixing of resin. In the preferred embodiment, approximately 4-6 lbs of concentrate are added for every 450 pounds of thermoset resin to be used in the Cured-In-Place-Pipe open-molding/closed molding. The thermoset resin may be most any commercially available resin, such as those available from AOC, Inc., Interplastics or Reichhold, provided only that it is a premium, high molecular weight, ISO resin. Filled (ATH/enhanced) resins may also be used, but in this case less than half the above-stated amount of thickener is required.

The thickening agent comprises a calibrated mixture of neutral polyester resin carrier with an active agent comprising Magnesium Oxide (MgO) paste and a desiccant such as anhydrous Calcium Chloride in the following concentrations and ranges.

1. neutral polyester resin carrier (varying amount)

2. active thickening agent
98.5% Magnesium Oxide (MgO) paste±10%
1.5% of Calcium Chloride (anhydrous)±10%

The neutral polyester resin carrier may be a 40-60 weight % polyester resin such as available from PlastiColors, Inc. as product PG 9033 or AM 9033, or equivalent.

The MgO paste is a 40% by weight MgO paste in the above-described polyester resin (no monomer). Suitable MgO pastes are available from various commercial sources, such as Barcroft Company.

The Calcium Chloride is a desiccant reagent (anhydrous CaCl₂) comprising a small amount (1.5 phr) of anhydrous CaCl₂ addition to the MgO paste that causes reaction times to increase significantly producing results in 2-8 hours depending on the resin used and the concentrations added (0.75-2%). Calcium Chloride is available from Fischer Scientific as product number C-614 or equivalent, which comprises a powder formed of 840 micron pellets. This is a hydroscopic powder (absorbs moisture)

To formulate the thickening agent, the following steps are performed:

1st.) Grind the Calcium Chloride powder into fine powder (range: 5-210 micron) to increase solubility into the MgO paste. Note: grinding must be done in dry conditions so as not to absorb humidity in air.

2d:) Add CaCl₂ to Paste: approximately 1.5 phr (parts per hundred)

3d.) Mix the foregoing with MgO paste,

4th.) Package in a sealed container, keeping moisture free or the solution will loose it's effectiveness.

To use the above-described thickening agent, 0.75 to 2 percent by weight of the mixed thickening agent is added to the polyester thermoset resin prior to curing. Thickening time for workability is 3-4 hours and can be adjusted up to 6-10 hours depending on the resin and conditions. Six hours of wet out time and consistent thickening within 24 hours is the primary advantage of the present agent when used in small pipes, 12-16 hours in large pipes. The additive is well suited for any Cured-In-Place Pipe applications or other polyester resin processes that requires a quicker thickening product as well as a higher end thickening result.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A thickening agent for use in thickening polyester resin in Cured-In-Place-Pipe molding processes, comprising:
a neutral polyester resin binder; and
an active thickener including a mixture of Magnesium Oxide (MgO) paste and Calcium Chloride;
wherein said thickening agent may be added to a polyester thermoset resin prior to curing to facilitate thickening.

2. The thickening agent for use in thickening polyester resin as in claim 1 wherein 0.75 to 2 percent by weight of the mixed thickening agent added to every 450 pounds of polyester resin to be used in the Cured-In-Place-Pipe open-molding/closed molding processes for thickening said polyester resin within a range of from 2-8 hours.

3. The thickening agent for use in thickening polyester resin as in claim 1, wherein said active thickener further comprises approximately 98.5% Magnesium Oxide (MgO) paste within a range of ±10%, and approximately 1.5% of Calcium Chloride (anhydrous) within a range of ±10%.

4. The thickening agent for use in thickening polyester resin as in claim 3, wherein said active thickener further comprises 98.5% Magnesium Oxide (MgO) paste, and 1.5% of Calcium Chloride (anhydrous).

5. The thickening agent for use in thickening polyester resin as in claim 1, wherein said active thickener further comprises MgO paste added 40% by weight into said polyester resin.

6. The thickening agent for use in thickening polyester resin as in claim 5, wherein said Calcium Chloride comprises approximately 1.5 phr of anhydrous CaCl₂.

7. The thickening agent for use in thickening polyester resin as in claim 1, wherein said neutral polyester resin carrier is a 40-60 weight % polyester resin.

8. The thickening agent according to claim 1, formed in accordance with the following method steps:
grinding said Calcium Chloride from pellet form into fine powder in a range of from 5-210 microns to increase solubility;
mixing said ground Calcium Chloride with said MgO paste;
packaging in a sealed container, keeping moisture free.
